(19) United States
(12) Patent Application Publication
(10) Pub. No.: US 2020/0092803 A1
(43) Pub. Date: Mar. 19, 2020

(54) Providing Network Connection Delineation

(71) Applicant: International Business Machines Corporation, Armonk, NY (US)

(72) Inventor: Martin Presler-Marshall, Chapel Hill, NC (US)

(73) Assignee: International Business Machines Corporation, Armonk, NY (US)

(21) Appl. No.: 16/132,180

(22) Filed: Sep. 14, 2018

(51) Int. Cl. H04W 48/20; H04W 76/10; H04W 24/02; H04W 24/08; H04W 48/16; H04L 12/26; H04B 17/364

(52) U.S. Cl. CPC H04W 48/20; H04W 76/10; H04W 24/02; H04W 72/08; H04W 48/16; H04L 43/0852; H04B 17/364; H04W 24/08

(57) ABSTRACT

Embodiments relate to a system, computer program product, and method for evaluating one or more network characteristics commensurate with establishing a connection between a computing device and a network. A computing device configured as a network accessible device selectively detects one or more available network connections, followed by initiating establishment of the connection, which includes an automatic analysis of the device connection to the network. This analysis employs a measurement of latency commensurate with the selected network connection. The functionality of the computing device is dynamically adjusted responsive to the latency measurement. More specifically, the functionality adjustment is selective and based on a categorization of the latency measurement.

### BACKGROUND

The present embodiments relate generally to computer networks, and in particular to connection of one or more computing devices to a computer network. More specifically, the embodiments relate latency measurement of a network connection, and dynamic adjustment of an associated physical computing device or device setting responsive to the latency measurement.

The implementation and utilization of computer networks are growing at a high rate as use of computers and other computing devices increases, together with mobility usage of computing devices. WiFi is a standard wireless local area network (WLAN) technology for connecting computers and electronic devices to a network access point which has a connection to the Internet. WiFi networks operate according to the Institute of Electrical and Electronic Engineers (IEEE) 802.11 standard, which is supported by many hardware vendors. Mobile and non-mobile computing devices are commonly configured with WiFi chips to enable the device to connect to a wireless network via a router. These WiFi networks typically have a range with performance likely to degrade as distance to the network increases.

In order to provide distributed wireless access to a network, network service providers typically provide geographically dispersed wireless access ports. These wireless access ports provide WiFi access points that allow computer users to access the Internet via their associated device, e.g. laptop, mobile phone, etc. Each working wireless access port emits a wireless signal configured to be recognized by a wireless capable mobile device. The mobile device may latch onto the wireless signal(s), and are able to access the network via a series of authentication procedures with the background network, depending on whether the network is openly available or requires a form of payment or subscription.

The Internet connection behind the WiFi connection may be classified as metered and non-metered. The metered classification is a service model in which an Internet Service Provider (ISP) tracks bandwidth use and charges accordingly. A metered device commonly results in a fee charged by the ISP for use of the connection, and as such when the device is connected via a metered connection, access to the network can become expensive. Conversely, a non-metered connection may or may not track bandwidth use, and does not limited connection or associated data usage.

### SUMMARY

The embodiments described herein include a system, computer program product, and a method for selectively establishing a connection between a computing device and a network, including establishing one or more devices settings responsive to one or more connection characteristics.

In one aspect, a computer system is provided with a processing unit operatively coupled to memory. The system is configured with tools to establish and evaluate network connection characteristics, and to selectively adjust a system setting responsive to the evaluation. The tools include a network detector, an analyzer, and an adjuster. The network detector functions to detect one or more network connections to selectively establish a connection between an associated computing device and the network. The analyzer, which is operatively coupled to the network detector, functions to automatically analyze the connection between the computing device and the network. The analysis includes execution of a latency measurement of the connection. The adjuster, which is operatively coupled to the analyzer, functions to dynamically adjust functionality of the associated computing device responsive to the latency measurement. The functionality adjustment is selective based on a categorization of the latency measurement.

In another aspect, a computer program product is provided for processing instructions for measuring latency of an associated network connection. The computer program product employs a computer readable storage device having program code embodied therewith and executable of a processing unit. The program code includes instructions to detect an available network connection to a network accessible device, and to selectively establish a connection of a computing device to the network. Program code automatically analyzes the device connection, with the analysis includes execution of a latency measurement of the connection. Responsive to the latency measurement analysis, program code dynamically adjusts functionality of the device. In one embodiment, the latency measurement is placed into a category, and the dynamic adjustment is based on the category.

In yet another aspect, a method is provided for evaluating one or more network characteristics responsive to or as part of establishing a connection between a computing device and a network. The device is configured as a network accessible device and selectively detects one or more available network connections. In response to selection of a network connection, the process of establishing the connection is initiated, with the process includes an automatic analysis of the device connection to the network. This analysis includes a measurement of latency commensurate with the selected network connection. The functionality of the computing device is dynamically adjustment responsive to the latency measurement. More specifically, the functionality adjustment is selective and based on a categorization of the latency measurement.

These and other features and advantages will become apparent from the following detailed description of the presently preferred embodiment(s), taken in conjunction with the accompanying drawings.

### BRIEF DESCRIPTION OF THE SEVERAL VIEWS OF THE DRAWINGS

The drawings referenced herein form a part of the specification. Features shown in the drawings are meant as illustrative of only some embodiments, and not of all embodiments unless otherwise explicitly indicated.

FIG. 1 depicts a schematic diagram of a networked computer environment in accordance with an embodiment.

FIG. 2 depicts a schematic diagram of a computer system provided with one or more tools to access device settings and associated functionality with respect to network latency measurement.

FIG. 3 depicts a flow chart illustrating a process for automatically assessing a network connection.

FIG. 4 depicts a flow chart illustrating network characteristic assessment and related computing device configuration.

FIG. 5 depicts a block diagram illustrating an example of a computer system/server of a cloud based support system, to implement the process described above with respect to FIGS. 1-4.

FIG. 6 depicts a block diagram illustrating a cloud computer environment.

FIG. 7 depicts a block diagram illustrating a set of functional abstraction model layers provided by the cloud computing environment.

### DETAILED DESCRIPTION

It will be readily understood that the components of the present embodiment(s), as generally described and illustrated in the Figures herein, may be arranged and designed in a wide variety of different configurations. Thus, the following detailed description of the embodiments of the apparatus, system, and method, as presented in the Figures, is not intended to limit the scope of the embodiments, as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiment of the present embodiments. Thus, appearances of the phrases “a select embodiment,” “in one embodiment,” or “in an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

Mobile computing devices, e.g. tablets, smartphones, etc., are hungry for network bandwidth. It is understood that each network connection has an associated bandwidth and speed. At the same time, the service provided supporting the network connection may provide different classifications for multiple network connections. In one embodiment, the classification aligns with the bandwidth and speed.

Connections of computing devices to the Internet may be classified as metered or non-metered. It is understood that mobile devices with a cellular data connection provide data-limiting features when the device is on a cellular connection, e.g. metered connection. WiFi is one example of technology that provides an avenue for a computing device to connect to a network access point. That network access point then has a connection to the Internet. It is this connection that may or may not be metered. It is understood that WiFi access points are commonly have non-metered Internet connections, although not always. However, the WiFi access point(s) does not provide information about the characteristics of the connection, e.g. metered or non-metered. When connecting to a WiFi access point, users must then inform their device that the connection is in fact metered. In one embodiment, the user must provide this information via one or more operating system settings. For example, some operating systems will restrict system or application updates over a cellular connection, with the restriction having a manual over-ride. Examples of the metered connection include, but are not limited to, a mobile 4G hotspot or a satellite data connection. Such connections are not classified by the computing device as a metered connection. Any change in the classification of the connection between metered and non-metered would require manual intervention.

The present embodiments described in detail below together with the associated drawing figures provide a system, computer program product, and method to automatically analyze a device connection to a data network, and activate a data-saving feature of a computing device operating system based on the analysis.

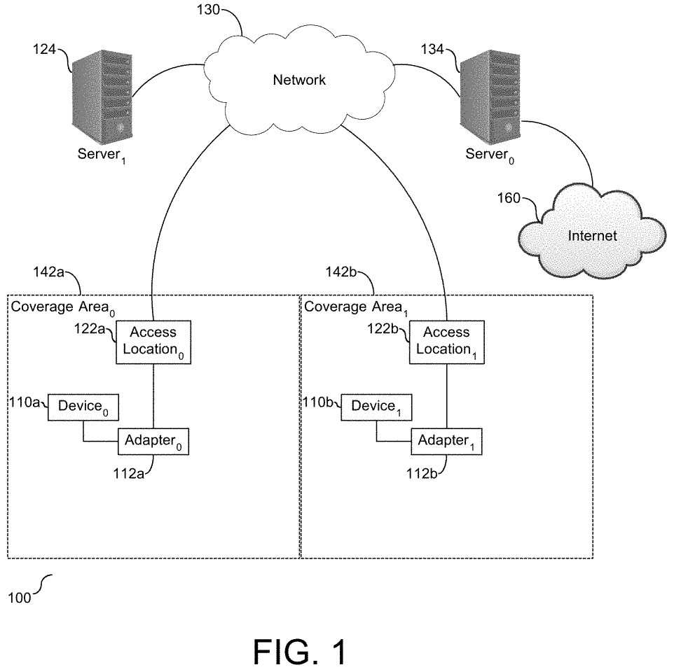

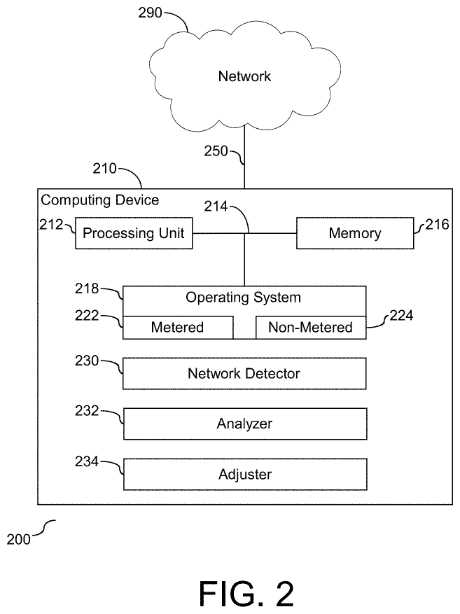

Implementations of the embodiments are provided and described together with the Figures. Within the description of the figures, similar elements are provided similar names and reference numerals throughout the figure(s). Where a later described figure utilizes an element in a different context or with different functionality, the element is provided a different leading numeral representative of the figure number, e.g. 1xx for FIG. 1, 2xx for FIG. 2, etc. The specific numerals assigned to the elements are provided solely to aid in the description and not meant to imply any limitations, structural or functional, on the embodiments.

Referring now to FIG. 1, a schematic diagram of a networked computer environment (100) is depicted in accordance with an embodiment. A service provider (120) is shown with discoverable connections at an associated network. The network shown herein is a wireless computer network. Computing devices may be any type of handheld of portable device, including but not limited to, a laptop, desktop, tablet, mobile telephone, etc. Two computing devices, device₀ (110a) and device₁ (110b) are shown herein, although the quantity of devices should not be considered limiting. Each of the devices, device₀ (110a) and device₁ (110b), include an associated network adapter, shown herein as network_adapter₀ (112a) and nework_adapter₁ (112b), respectively, to facilitate connection of the respect device to the network (130), which in one embodiment may be a wireless network. The network (130) is shown with multiple access points, also referred to herein as access location₀ (122a) and access location₁ (122b). Although only two access locations are shown and described, the quantity should not be considered limiting. Each access location (122a) and (122b) is connected to a distributed information network (130) that includes one or more servers (134) of one or more network access providers, shown herein as server₀ (134). Although only one server is shown herein, this is for illustrative purposes, and the network may be configured with multiple servers of one or more network access providers. In one embodiment, the server(s) (134) is referred to as a backend server. The server(s) (134) provides a wired or wireless connection to the Internet (160).

Each access location (122a) and (122b) may include a radio frequency (RF) or Bluetooth transceiver (not shown). Similarly, in one embodiment, one or more front end servers (124), shown herein as server₁, are provided operatively coupled to the distributed network (130). Although only one front end server (124) is shown, this quantity should not be considered limiting. In one embodiment, the network (100) may be configured with multiple front end servers (124). The front end server(s) (124) executes an operating system to implement a communication protocol via an antenna for short-range wireless systems, such as Bluetooth or WLAN, and an antenna for cellular networks, such as global system mobile (GSM) or CDMA. The front end server(s) (124) includes an application for establishing a session with one or more computing devices (110a) and (110b), and recognizing an associated address of the device. The access locations (122a) and (122b) are coupled to the Internet (160) through the server(s) (134) via a wireless link or a wired connection.

Access locations (122a) and (122b) are geographically dispersed and may be utilized to provide devices (110a) and (110b) with access to the service provider associated with server(s) (134) and the Internet (160) whenever the computing devices (110a) and (11b) are within an associated coverage area, shown herein as coverage area₀ (142a) and coverage area₁ (142b), respectively. Any number of access points may be available to devices (110a) and (110b) within a geographical area. The present embodiment is merely an example of access points and establishing an associated connection. Access areas and locations may be adjacent to each other or geographically dispersed. In one embodiment, the access locations (122a) and (122b) may be commercially available from several manufacturers or service providers. The access locations may be metered or non-metered. Accordingly, the physical components for establishing and maintaining a network connection for one or more computing devices (110a) and (110b) are shown and described.

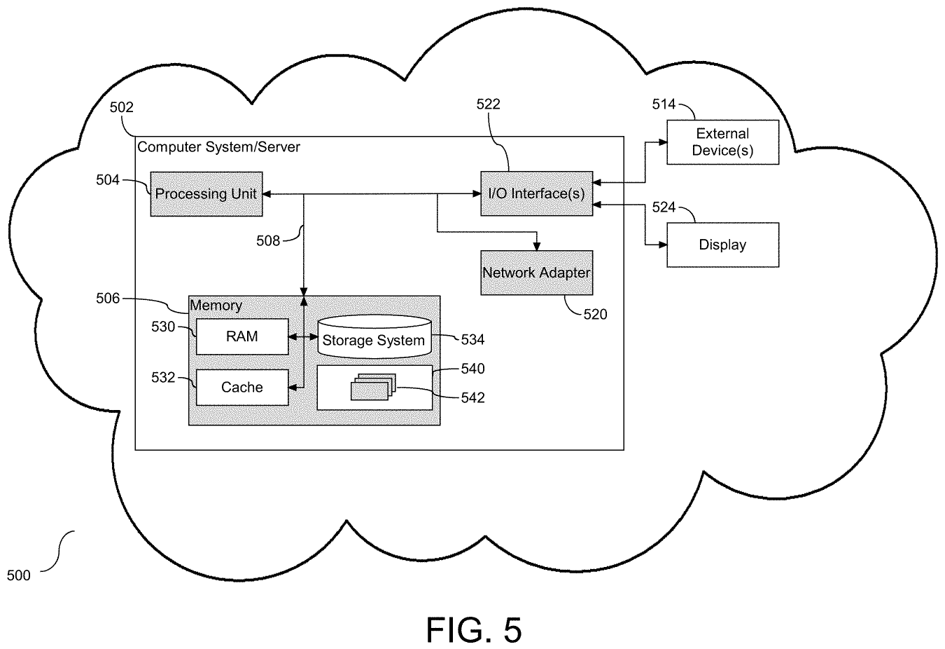

Referring to FIG. 2, a schematic diagram of a computer system (200) is provided with one or more tools to access device settings and associated functionality with respect network latency measurement. The tools shown and described herein are local to the mobile computing device, although this embodiment should not be considered limiting. In one embodiment, the tools shown and described in FIG. 2 may be embodied as an application that may be embedded local to the mobile computing device. Similarly, in one embodiment, the tools or application may be accessible to the computing device across a network connection. In one embodiment, the tools shown and described in FIG. 2 may be embedded on a server accessible to the mobile device through a network connection, as shown and described in FIGS. 5-7.

As shown, the system (200) is provided with a mobile computing device (210), which includes a processing unit (212), e.g. processor, operatively coupled to memory (216) and an operating system (218) across a bus (214). The memory (216) is configured with or operatively coupled to tools to support network access connection and support. As shown herein, the tools include, but are not limited to, a network detector (230), an analyzer (232), and an adjuster (234). The processor (212) supports execution of the tools (230)-(234). The network detector (230) functions to detect available network connections, e.g. WiFi connections, for the computing device (210). Once the connection is selected, a connection (250) is established between the device (210) and an available network (290). It is understood that different network connections have different characteristics. In the embodiments shown and described herein, the connection (250) may be classified as metered or non-metered. Regardless of the quantity of available connections, the aspect of establishing the connection may be selective based on characteristics of the network (290) and/or characteristics of the connection (250).

The established connection (250) is evaluated in order to maintain or service the connection. As shown, the analyzer (232) is operatively coupled to the detector (230). The analyzer (232) functions to analyze one or more characteristics of the connection (250). In one embodiment, the connection (250) is a temporary connection until the analyzer (232) completes the associated connection analysis. More specifically, the analyzer (232) assesses one or more characteristics of the connection (250) and designates a categorization of the connection (250). One of the assessments includes latency of the connection. Latency is a characteristic of the connection that measures how much time it takes for a packet of data to be transmitted. Network connections in which small delays occur are referred to as low-latency networks, whereas network connections in which large or larger delays occur are referred to as high-latency networks. In addition to the latency measurement, the analyzer (232) determines whether the connection (250) is metered or non-metered. In one embodiment, the analyzer (232) marks or otherwise designates the connection as a metered connection. Accordingly, at least two factors directed at the connection (250) and are analyzed, including latency and metering characteristics.

As shown, the adjuster (234) is operatively coupled to the analyzer (232). The adjuster (234) functions to dynamically adjust one or more functional aspects to the device (210) in response to the latency measurement and/or associated latency characteristic(s) and the connection classification. In one embodiment, measurement of network latency is a suggestion of the connection classification, and an intervention with the device may be necessary to obtain a precise connection classification. More specifically, the adjustment is selective, and in one embodiment is directed at the device operating system (218). If the connection characteristic(s) is designated by the analyzer (232) as metered, the adjuster (234) automatically activates a metered connection mode of the operating system (218). Similarly, if the connection characteristic(s) is designated as non-metered, the adjuster automatically activates a non-metered connection mode of the operating system (218). It is understood that the operating system may be set for the metered or non-metered mode, and the adjuster (234) may assess or otherwise identify the operating system mode setting, with the adjuster (234) dynamically changing the associated setting(s) of the operating system (218) responsive to the identified network connection mode. Accordingly, the adjuster (234) interfaces with the analyzer (232) and the operating system (218) to align the network connection characteristic with a mode setting of the operating system (218).

As described, it is understood that with the metered connection, the network provider accounts for time, data, and/or bandwidth utilized by the connected device (210). The operating system (218) is configured with at least two modes, including a metered mode (222) and a non-metered mode (224). Each of the modes has associated operating system characteristics and operating system settings. The operating system (218) employs selection of the modes to adapt to the metered connection so that use of the network connection is cognizant and responsive to the associated metering.

In another aspect, the analyzer (232) identifies an associated strength of signal of the connection (250). The signal strength may be a relative assessment or a specific strength value.

In one embodiment, the device (210) may have a minimum signal strength requirement in order to a conduct network communication. Similarly, in one embodiment, the signal strength is proportional to communication efficiency, and thereby associated costs with a metered connection. In one embodiment, the analyzer (232) assesses a difference between the latency of the established connection (250) and the typical latency to a proximally positioned server (not shown). The analyzer (232) is configured to identify a minimum signal strength, which in one embodiment may be a pre-requisite to execution of the latency measurement. Accordingly, both the signal strength and latency measurement are connection characteristics that are determined and assessed by the analyzer (232) with the adjuster (234) executing any changes to the device (210) and functionality of the device (210).

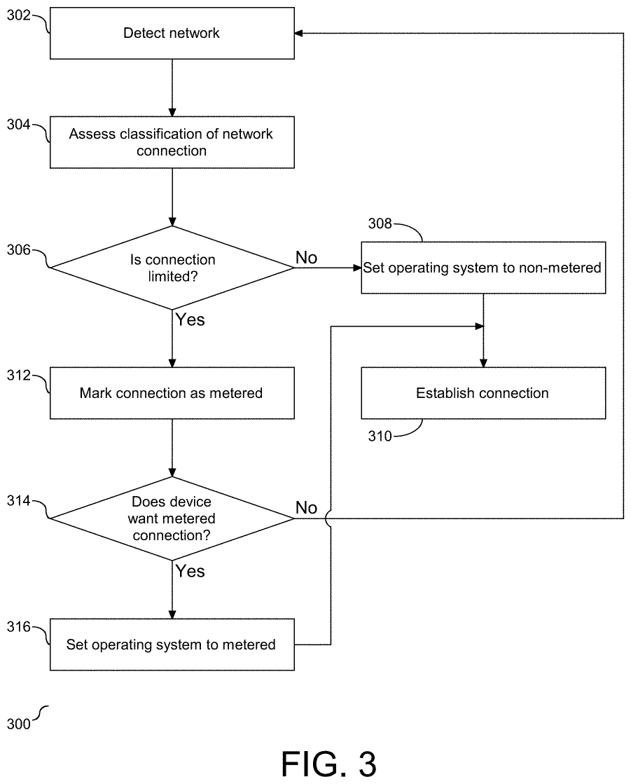

Referring to FIG. 3, a flow chart (300) is provided illustrating a process for automatically assessing a network connection. It is understood that various forms of computing devices are configured to connect to an available network. Classifications of network connection are commonly referred to as metered and non-metered, although the quantity of the classifications should not be considered limiting. The metered connection classification is a network connection where a device has a limited amount of data usage per time period. The metered connection classification tracks all data usage in excess of the limited amount in the set time period. In one embodiment, an associated service provider may assess a fee for data usage in excess of the limited amount.

When a computing device is determined to be within proximity of a network connection, the WiFi network is detected (302), and the classification of the network connection is assessed (304). The device may automatically select the detected connection, or in one embodiment, the connection of the device may be manual. Regardless of the manner in which the network connection is established, it is determined if the connection is limited, e.g. a metered connection, (306). If it is determined that the connection is non-metered at step (306), the operating system mode of the connecting device is set to non-metered (308), and the connection of the device to the network is established (310). It is understood that there are various secondary factors that are involved in network selection and establishment of a connection, including but not limited to network security. However, the scope of the embodiments herein are directed at a different aspect, and as such, the secondary network selection factors will not be described in detail.

At step (306), it is understood that the device connecting to the network may establish a limited network connection (312), referred to herein as a meter connection, in response to determining that the connection is limited. In one embodiment, at step (312), the connection being established is marked as a metered connection. There may be various factors that are embodied in selection of the metered network, including but not limited to, strength of the connection and security. It is determined if the device wants to recognize the characteristics of the network (314). More specifically, at step (314), it is determined if the device wants to establish a connection to the metered network connection. A negative response to the determination at step (314) is followed by a return to step (302) to search for and detect other network connections. Conversely, a positive response to the determination at step (314) is followed by setting the operating system mode of the connecting device to metered (316). In one embodiment, the operating system mode may already be set to metered, and as such the operating system mode may not need to be changed. Although in one embodiment, the operating system mode may be set to non-metered, and at step (316) the operating system mode may be set to metered from non-metered. The metered connection mode of the operating system is also referred to herein as a data saving mode, which in one embodiment limits transmission of data across the network connection. Once the operating system mode is set at step (316), the connection of the device to the network is established (310). Accordingly, as shown herein, the network characteristics are assessed and identified, together with associated device settings and establishing connection with the network.

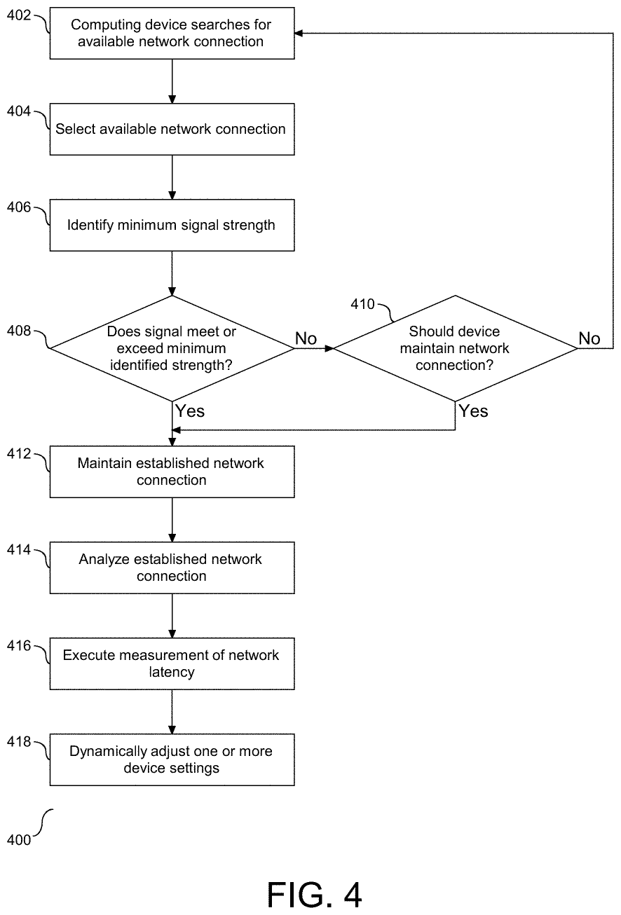

As shown and described, identifying network characteristics and configuring device settings responsive to the network characteristics affects how the underlying computing device functions with respect to network bandwidth utilization. Referring to FIG. 4, a flow chart (400) is provided illustrating network characteristic assessment and related computing device configuration. As shown, the computing device searches for an available network connection, e.g. available WiFi networks, (402). It is understood that in some locations there may not be any networks available for connection. Similarly, in one embodiment, there may be at least one connection available. In another embodiment, the device may be prompted at such time as a signal detects an available network connection, e.g. available WiFi network. Following step (402), the computing device selects an available network (404). The selection may be manual, or in one embodiment automated. It is understood that different network connections may have different signal strengths, depending on the connection, connection location, etc. Following the network selection, a minimum signal strength is identified (406). Although the identification is shown herein following selection of the available network, in one embodiment, the identification may occur prior to the network selection. Accordingly, as shown, as part of the network connection characteristic assessment, the network is selected and the minimum signal strength for the connection is identified.

Following step (406), it is determined if the signal for the selected network meets or exceeds the minimum identified strength (408). The minimum signal strength may be a requirement or a suggestion, although these embodiments should not be considered limiting. Following a negative response to the determination at step (408), it is determined if the device should maintain the network connection (410). In an embodiment with a minimum strength requirement, a negative response to the determination at step (410) is followed by a return to step (402) to search for another network connection. It is understood that with the minimum strength requirement, the return to step (402) may be automatic. A positive response to the determination at step (408) or step (410) is followed by maintaining the network connection (412) and analyzing the established network connection (414). As shown and described in FIG. 3 various elements of the network and network connection may be measured and analyzed. Following the analysis at step (414), a measurement of network latency is executed (416). As shown and described in FIGS. 1-2, the network latency measurement affects transmission of data across the network, and as such may affect device function. Based on the measurement at step (416), one or more device settings are dynamically adjusted (418), including but not limited to the operating system mode. Accordingly, in addition to signal strength assessment shown and described in FIG. 3, network latency is assessed, and device settings are adjusted to accommodate the latency measurement.

Aspects of the connection assessment and establishment shown in FIGS. 1-4 employ one or more functional tools, e.g. tools (230)-(234). The tools and their associated functionality may be embodied in a computer system/server in a single location, as an application in the single location, or in one embodiment, may be configured in a cloud based system sharing computing resources. With references to FIG. 5, a block diagram (500) is provided illustrating an example of a computer system/server (502), hereinafter referred to as a host (502) in communication with a cloud based support system, to implement the processes described above with respect to FIGS. 1-4. Host (502) is operational with numerous other general purpose or special purpose computing system environments or configurations. Examples of well-known computing systems, environments, and/or configurations that may be suitable for use with host (502) include, but are not limited to, personal computer systems, tablets, laptops, smart phones, server computer systems, thin clients, thick clients, hand-held or laptop devices, multiprocessor systems, microprocessor-based systems, set top boxes, programmable consumer electronics, network PCs, minicomputer systems, mainframe computer systems, and file systems (e.g., distributed storage environments and distributed cloud computing environments) that include any of the above systems, devices, and their equivalents.

Host (502) may be described in the general context of computer system-executable instructions, such as program modules, being executed by a computer system. Generally, program modules may include routines, programs, objects, components, logic, data structures, and so on that perform particular tasks or implement particular abstract data types. Host (502) may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, host (502) is shown in the form of a general-purpose computing device. The components of host (502) may include, but are not limited to, one or more processors or processing units (504), a system memory (506), and a bus (508) that couples various system components including system memory (506) to processor (504). Bus (508) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Host (502) typically includes a variety of computer system readable media. Such media may be any available media that is accessible by host (502) and it includes both volatile and non-volatile media, removable and non-removable media.

Memory (506) can include computer system readable media in the form of volatile memory, such as random access memory (RAM) (530) and/or cache memory (532). By way of example only, storage system (534) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus (508) by one or more data media interfaces.

Program/utility (540), having a set (at least one) of program modules (542), may be stored in memory (506) by way of example, and not limitation, as well as an operating system, one or more application programs, other program modules, and program data. Each of the operating systems, one or more application programs, other program modules, and program data or some combination thereof, may include an implementation of a networking environment. Program modules (542) generally carry out the functions and/or methodologies of embodiments to detect, analyze, and establish a connection of a device to an associated network. For example, the set of program modules (542) may include the modules configured as the detector (330), analyzer (332), and adjuster (334) in order to manage and assess network connections, associated connection characteristics, and selective and dynamic adjustment of one or more operating system settings, as described in FIGS. 1-4.

Host (502) may also communicate with one or more external devices (514), such as a keyboard, a pointing device, etc.; a display (524); one or more devices that enable a user to interact with host (502); and/or any devices (e.g., network card, modem, etc.) that enable host (502) to communicate with one or more other computing devices. Such communication can occur via Input/Output (I/O) interface(s) (522). Still yet, host (502) can communicate with one or more networks such as a local area network (LAN), a general wide area network (WAN), and/or a public network (e.g., the Internet) via network adapter (520). As depicted, network adapter (520) communicates with the other components of host (502) via bus (508). In one embodiment, a plurality of nodes of a distributed file system (not shown) is in communication with the host (502) via the I/O interface (522) or via the network adapter (520). It should be understood that although not shown, other hardware and/or software components could be used in conjunction with host (502). Examples, include, but are not limited to: microcode, device drivers, redundant processing units, external disk drive arrays, RAID systems, tape drives, and data archival storage systems, etc.

In this document, the terms “computer program medium,” “computer usable medium,” and “computer readable medium” are used to generally refer to media such as main memory (506), including RAM (512), cache (514), and storage system (516), such as a removable storage drive and a hard disk installed in a hard disk drive.

Computer programs (also called computer control logic) are stored in memory (506). Computer programs may also be received via a communication interface, such as network adapter (520). Such computer programs, when run, enable the computer system to perform the features of the present embodiments as discussed herein. In particular, the computer programs, when run, enable the processing unit (504) to perform the features of the computer system. Accordingly, such computer programs represent controllers of the computer system.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the embodiments.

In one embodiment, host (502) is a node of a cloud computing environment. As is known in the art, cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Example of such characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher layer of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some layer of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

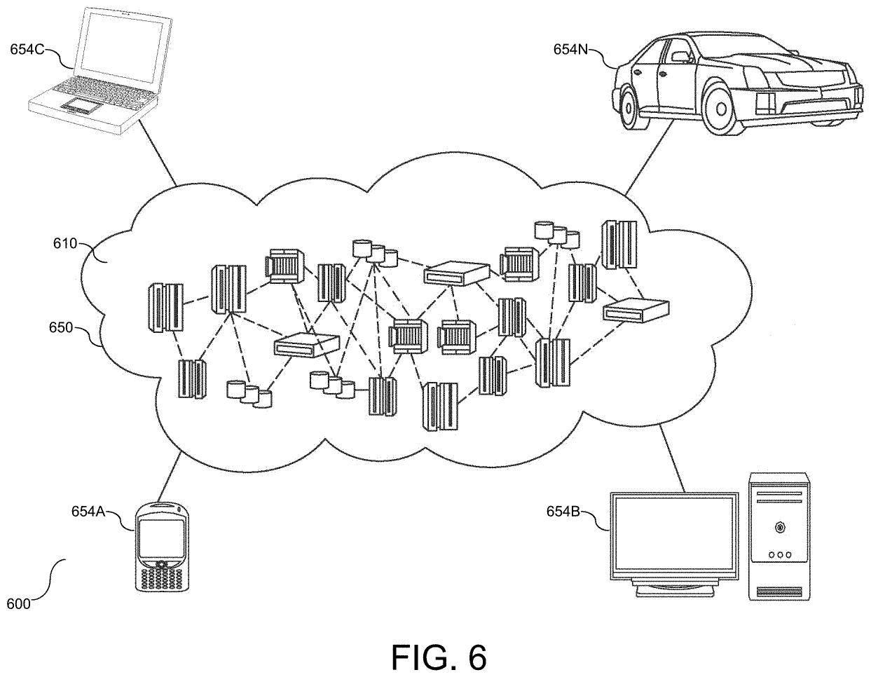

Referring now to FIG. 6, an illustrative cloud computing network (600). As shown, cloud computing network (600) includes a cloud computing environment (650) having one or more cloud computing nodes (610) with which local computing devices used by cloud consumers may communicate. Examples of these local computing devices include, but are not limited to, personal digital assistant (PDA) or cellular telephone (654A), desktop computer (654B), laptop computer (654C), and/or automobile computer system (654N). Individual nodes within nodes (610) may further communicate with one another. They may be grouped (not shown) physically or virtually, in one or more networks, such as Private, Community, Public, or Hybrid clouds as described hereinabove, or a combination thereof. This allows cloud computing environment (600) to offer infrastructure, platforms and/or software as services for which a cloud consumer does not need to maintain resources on a local computing device. It is understood that the types of computing devices (654A-N) shown in FIG. 6 are intended to be illustrative only and that the cloud computing environment (650) can communicate with any type of computerized device over any type of network and/or network addressable connection (e.g., using a web browser).

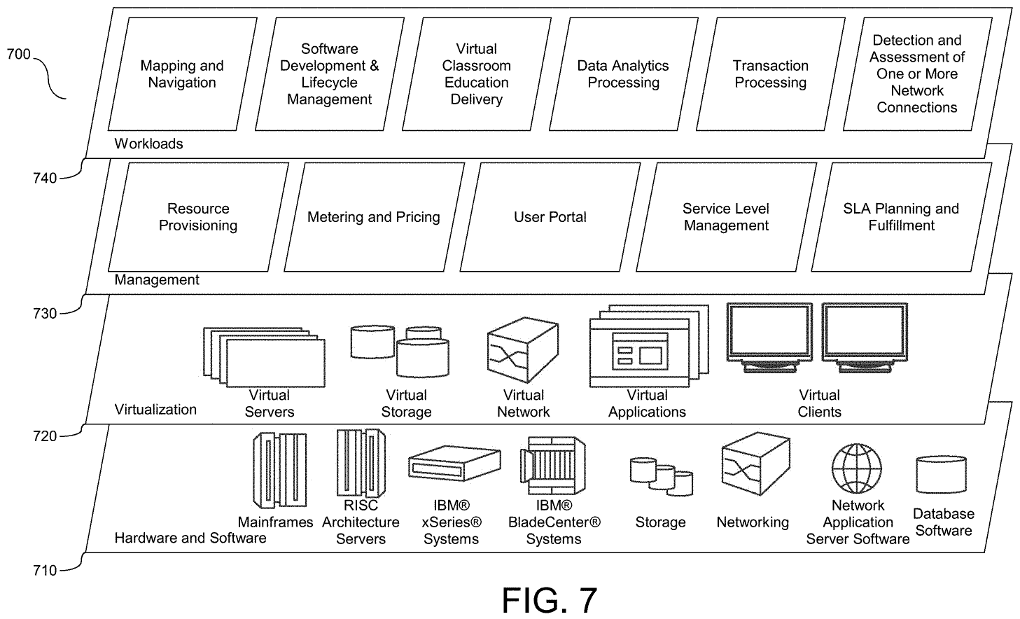

Referring now to FIG. 7, a set of functional abstraction layers (700) provided by the cloud computing network of FIG. 6 is shown. It should be understood in advance that the components, layers, and functions shown in FIG. 7 are intended to be illustrative only, and the embodiments are not limited thereto. As depicted, the following layers and corresponding functions are provided: hardware and software layer (710), virtualization layer (720), management layer (730), and workload layer (740). The hardware and software layer (710) includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer (720) provides an abstraction layer from which the following examples of virtual entities may be provided: virtual servers; virtual storage; virtual networks, including virtual private networks; virtual applications and operating systems; and virtual clients.

In one example, management layer (730) may provide the following functions: resource provisioning, metering and pricing, user portal, service layer management, and SLA planning and fulfillment. Resource provisioning provides dynamic procurement of computing resources and other resources that are utilized to perform tasks within the cloud computing environment. Metering and pricing provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service layer management provides cloud computing resource allocation and management such that required service layers are met. Service Layer Agreement (SLA) planning and fulfillment provides pre-arrangement for, and procurement of, cloud computing resources for which a future requirement is anticipated in accordance with an SLA.

Workloads layer (740) provides examples of functionality for which the cloud computing environment may be utilized. Examples of workloads and functions which may be provided from this layer include, but are not limited to: mapping and navigation; software development and lifecycle management; virtual classroom education delivery; data analytics processing; transaction processing; and detection and assessment of one or more network connections.

As will be appreciated by one skilled in the art, the aspects may be embodied as a system, method, or computer program product. Accordingly, the aspects may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, the aspects described herein may take the form of a computer program product embodied in one or more computer readable medium(s) having computer readable program code embodied thereon.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

The embodiments are described above with reference to flow chart illustrations and/or block diagrams of methods, apparatus (systems), and computer program products. It will be understood that each block of the flow chart illustrations and/or block diagrams, and combinations of blocks in the flow chart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow chart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flow chart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions, which execute on the computer or other programmable apparatus, provide processes for implementing the functions/acts specified in the flow chart and/or block diagram block or blocks.

The flow charts and block diagrams in the Figures illustrate the architecture, functionality, and operation of possible implementations of systems, methods, and computer program products according to various embodiments. In this regard, each block in the flow charts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flow chart illustration(s), and combinations of blocks in the block diagrams and/or flow chart illustration(s), can be implemented by special purpose hardware-based systems that perform the specified functions or acts, or combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The embodiments described herein may be implemented in a system, a method, and/or a computer program product. The computer program product may include a computer readable storage medium (or media) having computer readable program instructions thereon for causing a processor to carry out the embodiments described herein.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmissions, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The embodiments are described herein with reference to flow chart illustrations and/or block diagrams of methods, apparatus (systems), and computer program products. It will be understood that each block of the flow chart illustrations and/or block diagrams, and combinations of blocks in the flow chart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow chart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flow chart and/or block diagram block or blocks.

It will be appreciated that, although specific embodiments have been described herein for purposes of illustration, various modifications may be made without departing from the spirit and scope of the specific embodiments described herein. Accordingly, the scope of protection is limited only by the following claims and their equivalents.

What is claimed is:

1. A computer system comprising:
a processing unit operatively coupled to memory;
a network detector in communication with the processing unit, the network detector to detect availability of a network connection to a network accessible device;
the detector to establish a connection of the device to the network;
an analyzer in communication with the detector, the analyzer to automatically analyze the device connection to the network, including the analyzer to execute a latency measurement of the connection; and
an adjuster in communication with the analyzer, the adjuster to dynamically adjust functionality of the device responsive to the latency measurement, wherein the functionality adjustment is selective based on a categorization of the latency measurement.

2. The system of claim 1, wherein the dynamic adjustment further comprises the analyzer to:
designate the connection, wherein the designation is selected from the group consisting of: metered and non-metered.

3. The system of claim 2, wherein the connection is designated metered, and further comprising adjuster to automatically activate a metered connection mode of an operating system of the device.

4. The system of claim 1, further comprising the analyzer to identify a minimum network signal strength as a pre-requisite to executing the latency measurement.

5. The system of claim 1, wherein analysis of the device connection to the network further comprises the analyzer to:
assess a difference between a latency of the established connection and a latency to a proximally positioned server.

6. A computer program product for measuring latency of a network connection, the computer program product comprising a computer readable storage device having program code embodied therewith, the program code executable by a processing unit to:
detect availability of the network connection to a network accessible device;
establish a connection of the device to the network;
automatically analyze the device connection to the network, including execute a latency measurement of the connection; and
dynamically adjust functionality of the device responsive to the latency measurement, wherein the functionality adjustment is selective based on a categorization of the latency measurement.

7. The computer program product of claim 6, wherein the dynamic adjustment further comprises program code to:
designate the connection, wherein the designation is selected from the group consisting of: metered and non-metered.

8. The computer program product of claim 7, wherein the connection is designated metered, and further comprising program code to automatically activate a metered connection mode of an operating system of the device.

9. The computer program product of claim 6, further comprising program code to identify a minimum network signal strength as a pre-requisite to executing program code to measure latency.

10. The computer program product of claim 6, wherein the analysis of the device connection to the network further comprises program code to:
assess a difference between a latency of the established connection and a latency to a proximally positioned server.

11. A method comprising:
detecting availability of a network connection to a network accessible device;
establishing a connection of the device to the network;
automatically analyzing the device connection to the network, including executing a latency measurement of the connection; and
dynamically adjusting functionality of the device responsive to the latency measurement, wherein the functionality adjustment is selective based on a categorization of the latency measurement.

12. The method of claim 11, wherein the dynamic adjustment further comprises:
designating the connection, wherein the designation is selected from the group consisting of: metered and non-metered.

13. The method of claim 12, wherein the connection is designated metered, and further comprising automatically activating a metered connection mode of an operating system of the device.

14. The method of claim 11, further comprising identifying a minimum network signal strength as a pre-requisite to executing the latency measurement.

15. The method of claim 11, wherein analyzing the device connection to the network further comprises:
assessing a difference between a latency of the established connection and a latency to a proximally positioned server.
